(19) United States
(12) Patent Application Publication
(10) Pub. No.: US 2003/0230113 A1
(43) Pub. Date: Dec. 18, 2003

(54) Methods for manufacturing glass articles

(76) Inventors: Patrick Gedeon, Painted Post, NY (US); Michael D. Harris, Horseheads, NY (US); Robert Sabia, Corning, NY (US)

Correspondence Address: CORNING INCORPORATED, SP-TI-3-1, CORNING, NY, 14831

(21) Appl. No.: 10/171,219

(22) Filed: Jun. 12, 2002

(51) Int. Cl. C03C 10/16

(52) U.S. Cl. 65/33.3; 65/33.5; 65/54

(57) ABSTRACT

Methods of forming glass articles sensitive to aggressive heat treatment are disclosed. Glass preforms have sections of glass fusion bonded to the preforms, and the preforms are subsequently drawn into glass articles.

### FIELD OF THE INVENTION

This invention relates to drawing of glass articles. More particularly, the invention relates to methods for extending the length of glass preforms made from a glass sensitive to aggressive heat treatment.

### BACKGROUND OF THE INVENTION

The welding of the ends of optical fiber preforms to provide a continuous fiber drawing process is described in U.S. Pat. Nos. 4,407,667, 6,098,429, 6,178,779 and European patent application number 1057793A1. These patents and application describe processes that utilize torches, plasma torches or lasers to weld the ends of optical fiber preforms together. Optical fiber preforms are made from high purity fused silica doped with elements such as germania to either raise or lower the refractive index of portions of the preform. Generally, most optical fiber preforms must be heated aggressively to the softening point of glass which is about 10^{7 65} poise and requires heating the glass to at least about 2000° C. to weld the preforms together.

In addition to optical fibers, various types of products are made by drawing processes to form glass articles from preforms. For example, polarizing glass elements can be made by drawing glass preforms into rods, sheets or bars of glass from preforms of glass containing crystals. Polarizing glass typically comprises a glass composition containing a precipitated crystalline phase, such as precipitated metal halide crystals. Such glass compositions are known, and an example of such a glass is aluminum borosilicate glass containing silver halide precipitated crystals sold by the assignee of the present invention under the trademark Polarcor™. Gradient refractive index rods and lenses are examples of other products that utilize a draw process to produce articles from glass preforms. An example of such a process utilizes a glass composition containing high amounts of silver, for example, in excess of 2 cation percent silver ions to produce small diameter gradient refractive index rods from larger diameter preforms.

Both of the aforementioned draw processes typically involve a process of the type shown in FIG. 1. As shown in FIG. 1, a preform 10 includes an upper section 12. Clamping or holding mechanism 11 grips the upper section 12 so that the preform 10 can be positioned in or adjacent heating element or furnace 16. Lower section 18 of the preform deforms from the heat of the furnace or heating element 16, and the draw process is initiated as lower section 18 necks down to the appropriate dimension of the article to be formed. Typically, in addition to losing lower section 18 during the process, an intermediate section of glass 20 is lost during the draw initiation process until the proper geometrical tolerance of the article to be formed is achieved. In an example of a manufacturing process for polarizing glass articles, a preform approximately 48 inches in length yields only about 28 inches of usable glass. In a typical process, almost 20 inches of the preform is lost from upper section 14 gripped by the clamping or holding mechanism, the lower section 18 lost during draw initiation, and the intermediate section 20 of the preform 10 drawn until the proper geometrical tolerance is achieved. This results in an almost 40% loss of usable glass from the original preform 10.

It would be desirable to provide methods for fusing section of glass to glass preforms made from glasses sensitive to aggressive heat treatment. Examples of such glasses include, for example, glasses containing an element susceptible to precipitation and glasses containing a precipitated crystal phase susceptible to overgrowth. There is also a need to improve the yield of current draw processes in which unacceptably large portions of glass preforms are sacrificed during drawing operations. Thus, it would be advantageous to provide methods for joining sections of glass to a portion of a preform that could be sacrificed and increase the amount of usable glass from the preform.

### SUMMARY OF INVENTION

One embodiment of the invention relates to a method of manufacturing a glass article comprised of a glass sensitive to aggressive heat treatment. The method includes forming a preform of a glass material sensitive to aggressive heat treatment, the glass having top and bottom portions and fusion bonding sacrificial glass sections to at least one of the top or bottom portions of the preform. The preform, including the sections bonded thereto, is then drawn to provide a rod, sheet or strip of glass. In some embodiments, at least one of the glass sections is gripped during the drawing step.

The method is particularly useful for manufacturing polarizing glass articles, for example, polarizing glass articles including halide crystals. Such polarizing glasses are known in the art, and typically, the halide crystals include silver halide, copper halide, or copper-cadmium halide included in a base glass composition. A typical base glass composition for a polarizing glass is a borosilicate glass.

In certain preferred embodiments, the fusion bonding is performed at a temperature above the softening point of the glass. In some embodiments related to the manufacture of polarizing glass articles, a crystalline phase is developed in the glass during fusion bonding of the preform. For polarizing borosilicate glasses, the bonding is performed at a temperature exceeding 500° C., and more preferably at a temperature exceeding 700° C. In certain embodiments, the glass sections have essentially the same composition as the rod. In certain embodiments, the glass sections are section of sacrificial or rejected glass.

Another embodiment of the invention relates to a method of forming a glass article including providing at least two rods of glass containing an element susceptible to crystallization and fusion bonding the rods together at a temperature that avoids crystallization of the glass. An example of an element susceptible to crystallization is silver, and in certain embodiments, the silver is present in the glass in an amount exceeding 2 cation percent. In some embodiments, the fusion bonded rods have an initial diameter and the method further includes drawing the fusion bonded rods to rods having a diameter smaller than the initial diameter of the fusion bonded rods. In certain embodiments, the viscosity of the glass during the fusion bonding exceeds about 1×10^{7 65} Poise, which is the softening point of glass. The method according to this embodiment is useful for forming gradient refractive index lens rods.

The invention provides a relatively simple and inexpensive method of fusion bonding sections of glass together and avoids destruction of the glass properties that may occur with more aggressive heating methods. Additional advantages of the invention will be set forth in the following detailed description. It is to be understood that both the foregoing general description and the following detailed description are exemplary and are intended to provide further explanation of the invention as claimed.

### BRIEF DESCRIPTION OF THE DRAWINGS

FIG. 1 is a is a diagram of a prior art method for drawing a rod, sheet or bar of glass; and

FIG. 2 is a diagram of a method of drawing a rod, sheet or bar of glass according to one embodiment of the present invention.

### DETAILED DESCRIPTION

There are several types of glass that are sensitive to aggressive heat treatment. For example, glass compositions that contain precipitated crystals, such as polarizing glasses containing precipitated metal halide crystals, are very sensitive to high temperatures or to any additional post crystallization heat treatment. Another example of glasses sensitive to aggressive heat treatment are glasses that contain an element sensitive to crystallization at high temperatures and avoiding crystallization of the element is desired. These types of glasses should not be subjected to aggressive heat treatments such as the type used in optical fiber preform welding techniques utilizing aggressive heating methods such as torches, lasers, plasma. Applicants discovered that the aggressive heating techniques used for fusing optical fiber preforms together are not be suitable for fusing preforms of glasses that contain an element susceptible to crystallization and in which crystallization should be avoided and in glasses containing crystals susceptible to crystal overgrowth. Certain embodiments of the invention relate to fusion bonding of glasses containing precipitated crystals where excessive crystal growth adversely impacts final product performance.

As used herein, “a glass sensitive to aggressive heat treatment” refers to a glasses that cannot withstand excessive heat treatment from sources such as torches, plasma and flame welding techniques that are traditionally used in welding fiber optic preforms together. Examples of such glasses include, but are not limited to, glasses that contains a crystalline phase susceptible to overgrowth or glasses containing an element susceptible to crystallization when subjected to aggressive heat treatment. For certain types of glasses, it is desirable to avoid crystallization of certain elements contained in the glass.

As used herein, the terms “fusion” or “fusion bonding” refer to processes that involve heating the bonding surfaces and/or the material adjacent the bonding surfaces to the softening or deformation temperature of the articles bonded. In fusion bonding processes, typically two bonding surfaces are cleaned, the surfaces are placed in contact, and the surfaces are heated above the softening point of the materials being bonded (to the lower softening temperature for two dissimilar materials), thus forming a welded interface. Thus, by placing two surfaces into contact and heating to or above their softening temperature, the surfaces sag against (or mold into) each other to form a bonded interface. This process can be applied to glasses, to metals, and to dissimilar materials in terms of phase (e.g., metal, glass, glass-ceramic) and composition. An advantage of fusion bonding over other bonding techniques such as vacuum bonding and chemical bonding is that non-flat and rough surfaces can be fusion bonded with ease.

In one embodiment of the invention, glass articles containing a precipitated crystal phase can be bonded to sacrificial glass sections to provide elongated drawing preforms and improve the utilization of usable glass from the preform. An example of a product containing a precipitated crystal phase is polarizing glass such as Polarcor™ glass manufactured and sold by the assignee of the present invention. The manufacture of polarizing glass strips or sheets of glass typically consists of drawing rods cut into lengths approximately 48 inches in length. Prior to drawing, the rods are heat treated to develop the precipitated crystal phase. It is understood, that the present invention is not limited to preforms having a particular length, and the preform lengths discussed herein are only provided for the purposes of further illustrating certain embodiments of the invention.

A process for the production of polarizing glass is described in detail in U.S. Pat. No. 4,479,819, the contents of which are incorporated herein by reference. An example of a typical process for manufacturing a polarizing glass article includes four general steps:

(1) providing a batch for a high index glass containing metal particles such as silver, copper or copper cadmium and at least one halide such as a chloride, bromide, and iodide, melting the batch and shaping the melted batch into a glass body of a desired configuration;

(2) the glass body is subjected to a defined heat treatment to cause the generation of metal halide particles such as silver, copper-cadmium or copper halide particles in the body of a desired size;

(3) the glass body is elongated under stress within a defined temperature range to elongate the metal halide particles and to align them in the direction of the stress; and

(4) the elongated glass body is exposed to a reducing environment within a defined temperature range to reduce at least a portion of the metal halide particles to elemental or metallic silver which is deposited in and/or upon said elongated particles.

The observance of the heat treating parameters of each of steps (2), (3), and (4) is important to achieving the desired polarizing properties in the final product. To illustrate, the generation of silver or copper halide particles in the glass body requires temperatures above the strain point, preferably above the annealing point, and, where physical support is provided for the glass body as, for example, confinement in a mold, temperatures 50° C. in excess of the softening point of the glass can be utilized. Temperatures above the annealing point are economically desirable since, as is well-recognized in the art, particle growth occurs more rapidly as the temperature is raised, provided the maximum solubility temperature of the particles is not exceeded. The duration of heat treatment is typically between about two and six hours. The exact temperatures for each of the steps will depend on the composition of the glass and can be determined by routine experimentation.

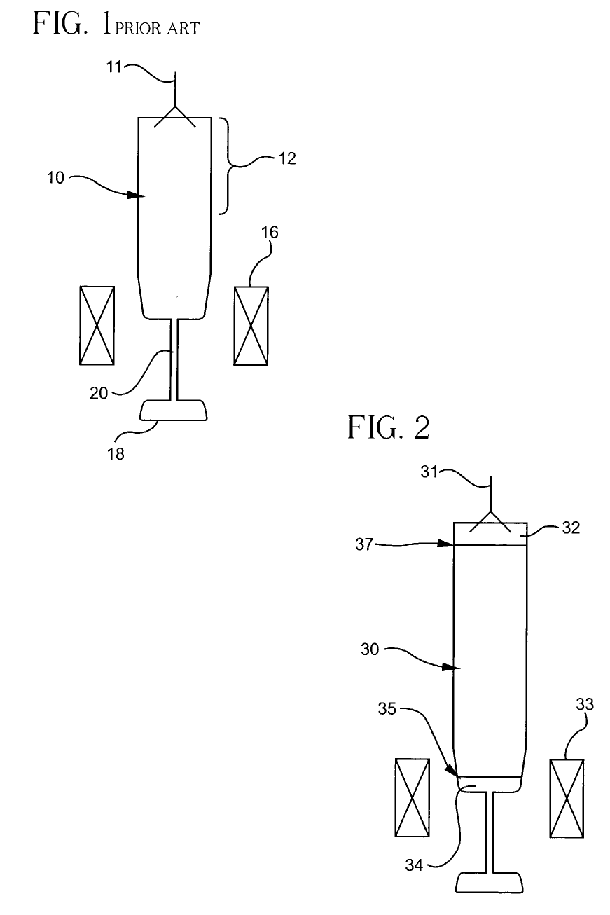

After the rods are heat treated to develop a crystal phase, the rods are surface ground, acid etched, and drawn into strips, rods or sheets using a process of the type shown in FIG. 1. The elongation of the glass body (and the metal halide particles previously generated therein) will be conducted at temperatures above the annealing point but below the softening point of the glass, i.e., at temperatures where the glass exhibits a viscosity greater than about 10^{7 65} Poises. In general, the elongation will be carried out at temperatures at least 50° C. below the softening point to allow high stresses to be developed and to prevent respheroidization of particles. Any heating of the glass article after generation of the metal halide particles must be performed in a carefully controlled manner. Accordingly, if preforms are fusion bonded together or if sections of sacrificial glass are bonded to the preform, heating must be performed carefully to prevent respheroidization of the metal halide particles.

A polarizing glass drawing process that utilizes a preform that is approximately 48 inches in length typically produces about 40 strips of glass approximately 40 mm long from the center portion of the rod. As discussed above, the lower portion of the rod is lost during draw initiation and the upper portion of the rod is lost due to clamping or gripping the upper portion, thus preventing strip production from the entire length. Although a preform comprised of a longer continuous rod could be provided to increase the amount of glass product produced by the preform, a significant amount of usable glass would be wasted during draw initiation and due to gripping of the upper portion of the glass.

One embodiment of the invention relates to a method of drawing a glass article including forming a rod or preform of glass sensitive to aggressive heat treatment, and extending the rod length by fusion bonding sacrificial glass sections to at least one or both of the upper and lower ends of the rod. As used herein, the term “sacrificial glass” refers to a glass that is lost or discarded during the draw production process. Sacrificial glass could include sections of glass that cannot be used in the production process either because the properties of the glass are not acceptable or the dimensions of the glass are not acceptable. The sacrificial glass sections may have essentially the same composition as the preform. The sacrificial glass sections may also be of a different composition than the preform, however, the sacrificial glass sections should have essentially the same coefficient of thermal expansion and glass viscosity at the drawing temperature of the glass preform to avoid problems during drawing due to thermal expansion or viscosity mismatch.

As shown in FIG. 2, preform or rod 30 includes upper glass section 32 and lower glass section 34 fusion bonded to the upper and lower ends of the preform or rod 30. Fusion of the upper glass section 32 and lower glass section 34 allows draw initiation and clamping or gripping on at least one of these sacrificial glass sections and drawing of strips of acceptable product from a greater length of the rod 30 during drawing by heating the rod in a heating element or furnace 33. Typically gripping or clamping mechanism 31 attaches to upper section 32. Such processing is expected to yield about 70 to 80 40 mm strips per each 48 inches of rod and a significant cost savings in terms of a reduction in lost material during the draw process.

Fusion bonding has been demonstrated on Polarcor™ glass rods at temperatures as low as 525° C. Although the softening temperature of Polarcor™ is reported as 662° C., bonding experiments revealed that fusion bonding can occur with this glass at temperatures lower than the softening temperature. As used herein the term softening temperature refers to the temperature at which the viscosity of the glass is equal to about 10^{7 65} poise. The actual bonding temperature will of course depend on the glass composition of the sections of glass being bonded, and on the surface quality of the interfaces being bonded (i.e., distance necessary for glass flow). One consideration to keep in mind when extending glass rods containing a precipitated crystal phase is the need to maintain constant rod width and depth across the entire length. Chemical bonding of rod sections would require intricate machining and polishing of highly flat rod ends to successfully bond sacrificial extension, whereas fusion bonding requires no such machining.

The development of silver halide crystals in Polarcor™ glass rods is typically performed at temperatures exceeding 700° C. in an oxygen environment to nucleate silver halide crystals that are further converted to Ag by hydrogen firing after draw. Because the crystal initiation is performed at a temperature well above the softening point of the glass and because a significant amount of flow occurs during this step, fusion bonding of glass sections to preforms or rods is preferably performed during the step of generation of the crystals in the glass.

An example of the steps required to fusion bond sections of Polarcor™ rods includes placing a piece of usable Polarcor™ between two rod sections, which may be glass sections contain rejected or unusable glass for polarizer application. All four surfaces in contact are cut square. Alignment of the surfaces is performed such that all three sections are at the same height and are straight along the length. During the heat treatment to develop crystals in the glass at about 700° C. or higher, the two rejected rod sections and the good rod bond end-to-end. Subsequent processing may include surface grinding, acid etching, and drawing to generate strips of polarizing glass. As shown in FIG. 2, the draw process is initiated on a sacrificial bottom section 34, with the process proceeding through a first fusion bond interface 35 before strips are saved (not rejected) from the good rod 30. This allows production of strips from the approximate bottom 5 inches of rod length that is conventionally wasted due to draw initiation and attainment of strip dimensional uniformity. At the top of the rod 30, the re-draw process is terminated just prior to a second bond interface 37, thus allowing generation of strips from more than 10 inches of rod length at the top that is not possible with the current process due to furnace and clamp designs.

With any draw process, drawn rods must be processed to a length that allows for handling and inspection. Although rod length can be increased to allow for the generation of more usable glass, the top and bottom are still unusable due to clamping and draw initiation respectively. Thus, the present invention is not limited in terms of the length in which rods are initially processed. Since rejected rods of glass containing precipitated crystals are common, the source for rod extension material for this application is essentially identical in composition to the rod, however such it not required as long as the coefficient of thermal expansion (CTE) for both materials -and viscosity at draw temperature are a relatively close match so as not to cause processing problems during drawing due to thermal expansion mismatch of differential viscosity at the bond interface.

Another embodiment of the invention may involve fusion bonding good or usable rod lengths continually to the top surface of the draw rod. It is possible for this bonding task to be performed during drawing, which would provide a continuous process that does not require disposal of glass for draw initiation (aside from the first rod) and only requires disposal of strips generated from the bond area.

Experiments with Polarcor™ rods have resulted in fusion bonds between rods sections generated by cutting a Polarcor™ in half. The cut rod was heated to and bonded at 700° C. according to standard practice for generating crystals in the glass. Fusion bonded Polarcor™ rods have been successfully surface ground and acid etched without causing failure. A fusion bonded Polarcor™ rod was successfully drawn to generate strips in a furnace and apparatus of the type shown in FIG. 2. Accordingly, it has been demonstrated that rods containing precipitated crystals can be extended during the crystal generation process by fusion bonding sections of glass to preform rods, thus allowing for drawing from an entire 48 inch rod rather than the approximately 28 inches that is now standard.

Another embodiment of the invention relates to a method of forming a glass article including providing at least two rods of glass containing an element susceptible to crystallization and fusion bonding the rods together at a temperature that avoids crystallization of the glass. In certain embodiments, the method may further include drawing the fusion bonded rods. An example of a glass containing an element susceptible to precipitation is glass containing a high percentage of silver ions. A particular example of such a glass is disclosed in co-pending and commonly assigned U.S. patent application Ser. No. 09/930,718, filed on Aug. 15, 2001 entitled, “High Silver Borosilicate Glasses,” the contents of which are incorporated herein by reference. These glasses are used to form glass rods via a draw process of the type shown in FIG. 1. The glasses are formed by batch melting the ingredients which contain greater than 2 cation percent, and preferably greater than 10 cation percent silver in the composition. Some compositions contain between 20 and 30 cation percent silver. Rods of glass are formed by pouring batch-melted glass into molds. A typical rod length is approximately 15 to 30 inches long. However, due to draw initiation in the furnace and gripping or clamping of an upper portion of the glass rod as shown in FIG. 1, approximately 6 inches of the 15 inches of glass rod produces a usable product. Typically, the rod preform having an initial diameter is drawn into a rod having a smaller diameter than the initial diameter to form a rod lens product.

Similar to the process described above for preforms of glass containing a precipitated crystal phase, the rod length of the glass preform rod can be extended prior to drawing to avoid the loss of usable glass from the preform. In addition, sacrificial or rejected glass rod sections can be fusion bonded to the upper and lower ends of the rod preform as shown in FIG. 2 to provide sections of glass that can be discarded, while utilizing a longer section of the preform or rod containing usable glass. Alternatively, continuous drawing can be provided by fusion bonding good sections of preforms together during the drawing process.

Experiments involving bonding sections of borosilicate glass containing amounts of silver in excess of 20 cation percent revealed that aggressive heating could not be used to form the fusion bond. Aggressive heating using techniques such as flame or torch, laser, or plasma welding resulted in a bonded interface containing crystallized glass. The crystallized bond interface failed during draw operation. In certain embodiments, the fusion bonding of glass sections should be performed such that the viscosity of the glass exceeds about 1×10^{7 65} Poise. Fusion bonding must also be performed in a manner that avoids forming cord or stones in the glass. In an example of such a process, borosilicate glass sections containing approximately 20 cation percent silver were fusion bonded in a furnace at a temperature between about 600° C. and 650° C. without crystallization.

Thus, the present invention provides methods of fusion bonding sections of glass sensitive to aggressive heat treatment such as glasses containing an element susceptible to precipitation or glass containing a precipitated crystal phase. Rod or preform length can be extended by fusion bonding section of preforms that have essentially identical compositions or thermal expansion or viscosity at drawing temperatures. Alternatively, the sections of sacrificial or rejected glass can be fusion bonded to at least one of or both the upper and lower sections of a preform to increase the utilization of usable glass from a preform. Preferably, fusion bonding or sealing is performed in a manner that requires little or no post bonding finishing procedures to correct for lost geometrical tolerances. An advantage of fusion bonding compared to other types of bonding techniques such as chemical or vacuum bonding is that the bonding surfaces do not require high flatness, and typically surfaces having a flatness greater than 1 micron can be successfully fusion bonded. Bonding is performed at temperatures that are not detrimental to the glass properties. Advantageously, sections of glass can be bonded during heat treatment of the glass to develop precipitated crystals in the glass. For glasses containing high amounts of silver and in which precipitated crystals are not desirable, fusion bonding is performed in a manner to avoid crystallization.

It will be apparent to those skilled in the art that various modifications and variations can be made to the present invention without departing from the spirit or scope of the invention. Thus, it is intended that the present invention cover modifications and variations of this invention provided they come within the scope of the appended claims and their equivalents.

What is claimed is:

1. A method of manufacturing a glass article comprised of a glass sensitive to aggressive heat treatment comprising:
forming a preform of a glass material sensitive to aggressive heat treatment, the glass having top and bottom portions;
fusion bonding sacrificial glass sections to at least one of the top or bottom portions of the preform; and
drawing the preform to provide a rod, sheet or strip of glass.

2. The method of claim 1, wherein the class contains a precipitated crystal phase susceptible to overgrowth or an element susceptible to crystallization.

3. The method of claim 1, further including gripping at least one of the glass sections during the drawing step.

4. The method of claim 3, wherein the glass article is a polarizing glass article including halide crystals.

5. The method of claim 4, wherein the halide crystals are selected from the group consisting of silver halide, copper halide, copper-cadmium halide, and combinations thereof.

6. The method of claim 4, wherein the fusion bonding is performed at a temperature above the softening point of the glass.

7. The method of claim 6, further comprising developing a crystal phase in the glass during the fusion bonding.

8. The method of claim 7, wherein the glass sections have essentially the same composition as the preform.

9. The method of claim 8, wherein the glass composition is an aluminum borosilicate glass.

10. The method of claim 9, wherein the bonding is performed at a temperature exceeding 500° C.

11. The method of claim 10, wherein the bonding is performed at a temperature exceeding 700° C.

12. The method of claim 7, wherein the glass sections have a different composition that the preform and have essentially the same coefficient of thermal expansion and glass viscosity at draw temperature as the preform.

13. A method of forming a glass article comprising:
providing at least two rods of glass containing an element susceptible to crystallization; and
fusion bonding the rods together at a temperature that avoids crystallization of the glass.

14. The method of claim 13, wherein the element susceptible to crystallization is silver.

15. The method of claim 14, wherein the silver is present in the glass in an amount exceeding 2 cation percent.

16. The method of claim 14, wherein the silver is present in an amount exceeding 10 cation percent.

17. The method of claim 13, wherein the fusion bonded rods have a first diameter and further comprising drawing the fusion bonded rods to rods having a diameter smaller than the first diameter of the fusion bonded rods.

18. The method of claim 13, wherein the viscosity of the glass during the fusion bonding exceeds about 1×10^{7 65} Poise.

19. A gradient refractive index lens rod formed by the method of claim 13.
